(19) United States
(12) Patent Application Publication
(10) Pub. No.: US 2010/0095330 A1
(43) Pub. Date: Apr. 15, 2010

(54) SATELLITE RECEIVER SYSTEM WITH RECHARGEABLE BATTERY AND ANTENNA SOLAR CELL

(75) Inventor: Rajiv Singh Cullen Pal, Denver, CO (US)

Correspondence Address: SETTER ROCHE LLP, PO BOX 780, ERIE, CO, 80516, US

(73) Assignee: ECHOSTAR TECHNOLOGIES L.L.C., Englewood, CO (US)

(21) Appl. No.: 12/251,877

(22) Filed: Oct. 15, 2008

(51) Int. Cl. H04N 7/20

(52) U.S. Cl. 725/68; 343/720

(57) ABSTRACT

A satellite receiving system is constructed including an antenna, a solar cell, and a set-top box receiver. The set-top box receiver includes a rechargeable battery electrically coupled to the solar cell, and a main power supply. The solar cell is configured to charge the rechargeable battery. The set-top box is configured to operate from either the rechargeable battery or the main power supply, and to operate from the rechargeable battery when the main power supply is turned off.

### BACKGROUND OF THE INVENTION

1. Field of the Invention

This disclosure is related to the field of satellite receiving systems, and, in particular, to satellite receiving systems including a solar cell and rechargeable battery configured to provide power to the system.

2. Description of the Prior Art

Many current satellite receiving systems are designed to perform a number of background tasks that may take place even while the system is not being used. When a user turns off such a satellite receiving system, it no longer provides video to the user but continues to perform background tasks as necessary. These background tasks cause the system to continue to draw power even when the user has turned the system off. If the user unplugs the system from the power source, the satellite receiving system will be unable to complete these background tasks and this may require the system to perform these tasks once the system is plugged back into the power source. In some cases, these background tasks may need to be performed before the satellite receiving system is operable. Depending on the complexity of the tasks to be performed before operation, they may require a substantial amount of time before the satellite receiving system is ready for use.

### SUMMARY OF THE INVENTION

A satellite receiving system is constructed including an antenna, a solar cell, and a set-top box receiver. The set-top box receiver includes a rechargeable battery electrically coupled to the solar cell, and a main power supply. The solar cell is configured to charge the rechargeable battery. The set-top box is configured to operate from either the rechargeable battery or the main power supply, and to operate from the rechargeable battery when the main power supply is turned off.

### BRIEF DESCRIPTION OF THE DRAWINGS

FIG. 1 is a block diagram of a satellite receiving system.

FIG. 2 is a flow chart of a method of constructing a satellite receiving system.

FIG. 3 illustrates a satellite receiving antenna.

FIG. 4 illustrates a satellite receiving antenna.

FIG. 5 illustrates a satellite receiving antenna.

FIG. 6 illustrates a set-top box receiver.

### DETAILED DESCRIPTION OF THE PREFERRED EMBODIMENT

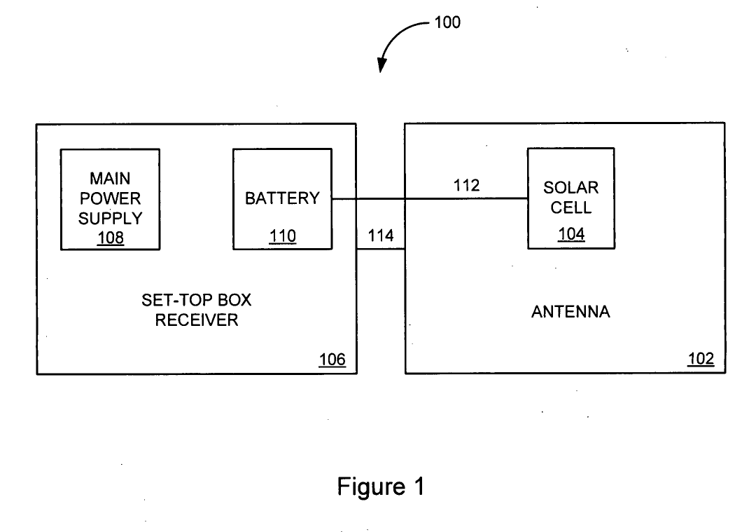

FIG. 1 is a block diagram of a satellite receiving system 100. In this example, the satellite receiving system 100 includes an antenna 102 and a set-top box receiver 106. Antenna 102 is configured to receive video signals from a satellite and transfer these signals to set-top box receiver 106 over link 114. The set-top box receiver 106 processes these video signals and creates a video output for display on a television (not shown).

When set-top box receiver 106 is turned off by a user, it continues to draw power in order to perform a variety of background tasks. These tasks include such processes as positive authorizations, code updates, encryption key changes, callback, and the like. Positive authorizations are piracy control features that set an end date, after which set-top box receiver 106 is automatically disabled. Every few days or weeks, set-top box receiver 106 receives a message via satellite updating the end date to some point in time in the future. If set-top box receiver 106 does not receive these messages updating the end date, it will cease to function on the last end date that it has successfully received.

Code updates are also sent via satellite to set-top box receiver 106 allowing set-top box receiver 106 to operate using the latest software available. Code updates may correct errors in previous code, or contain software upgrades enabling new features. Encryption key changes occur frequently as a method for preventing satellite signal piracy. In fact, these changes may occur several times a day in order to keep ahead of pirates. If set-top box receiver 106 does not receive the correct and latest encryption key, it will not operate. In some embodiments, pay-per-view programming, video-on-demand programming, or other programming may be downloaded to set-top box receiver 106 while set-top box is off, so that such programming will be available to the user at a later time.

Many set-top box receivers are configured to be connected to a telephone line (not shown). These receivers are configured to call a service center periodically to transmit information from the receiver to the satellite service provider. This information may include the identity of pay-per-view programming that has been ordered through the receiver, status information about the receiver, viewer preferences, satellite signal strength, and the like. This information may be necessary to provide correct billing to the user.

All of this background activity requires a supply of power to set-top box receiver 106. Energy conscious users may be aware of this power usage and may unplug the set-top box receiver from their power source in order to reduce power consumption. However, when power is no longer supplied to set-top box receiver 106, it is unable to complete these background tasks, which may require them to be performed when power is restored. This performance of backlogged tasks may require a delay before the system is ready for use.

In order to enable set-top box receiver 106 to perform background tasks when it is removed from a power source, receiver 106 includes main power supply 108 (typically connected to the power source), and rechargeable battery 110. Rechargeable battery 110 is coupled to solar cell 104 over link 112. Solar cell 104 is mechanically coupled with antenna 102. Since geosynchronous satellites orbit over the equator, satellite antennas in the northern hemisphere face a southward direction and satellite antennas in the southern hemisphere face a northward direction. Thus, satellite antennas typically point in a direction at least somewhat facing the path of the sun during the day. This fact makes satellite antennas ideal for use as a mounting point for solar cells.

In this example embodiment, antenna 102 includes solar cell 104 which is mechanically attached to antenna 102. Solar cell 104 is configured to charge rechargeable battery 110 through link 112. In this example, separate links are shown between solar cell 104 and battery 110, and between antenna 102 and set-top box 106. In other examples, links 112 and 114 may be combined into a single link. For example, many current satellite antennas are linked to their corresponding set-top boxes by a coaxial cable. In such a system, power from solar cell 104, may also flow through the same cable for use in charging rechargeable battery 110 within set-top box 106. Set-top box receiver 106 may also be configured such that battery 110 is recharged by main power supply 108 while connected to a power source. This allows battery 110 to be recharged during the night or other times when solar cell 104 is unable to supply power. While set-top box receiver 106 is powered by rechargeable battery 110, it may operate in a low-power mode to conserve energy. In a low-power mode, set-top box receiver 106 may perform only those background tasks which are considered necessary, and defer any other background tasks until main power supply 108 is turned on.

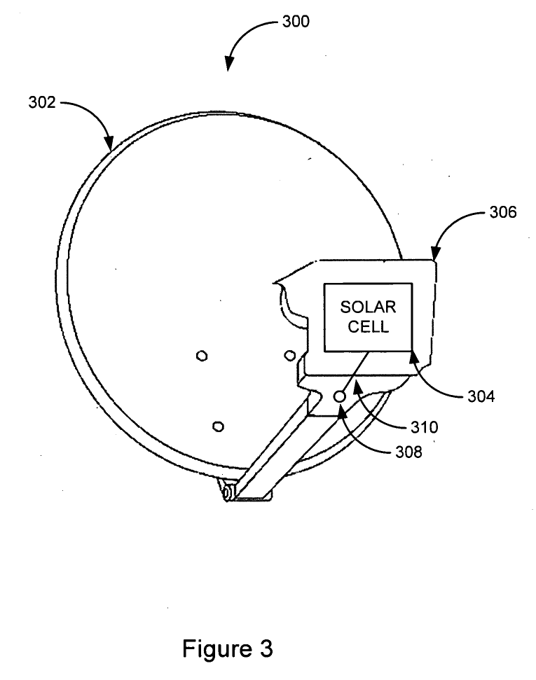

Solar cell 104 may be attached to antenna 102 in any of a wide variety of locations. For example, solar cell 104 may be constructed such that is has a satellite signal reflective surface. This would allow solar cell 104 to operate as part of the parabolic dish portion of antenna 102. In some embodiments, solar cell 104 may be constructed such that it forms part of the surface of the parabolic dish, while in other embodiments it may be attached to an edge of the parabolic dish and configured to act as an additional satellite signal reflector in addition to the parabolic dish. Still other antennas may be configured such that solar cell 104 is mechanically attached to a low-noise block converter portion of the antenna. Example configurations of antennas are illustrated in FIGS. 3 through 5.

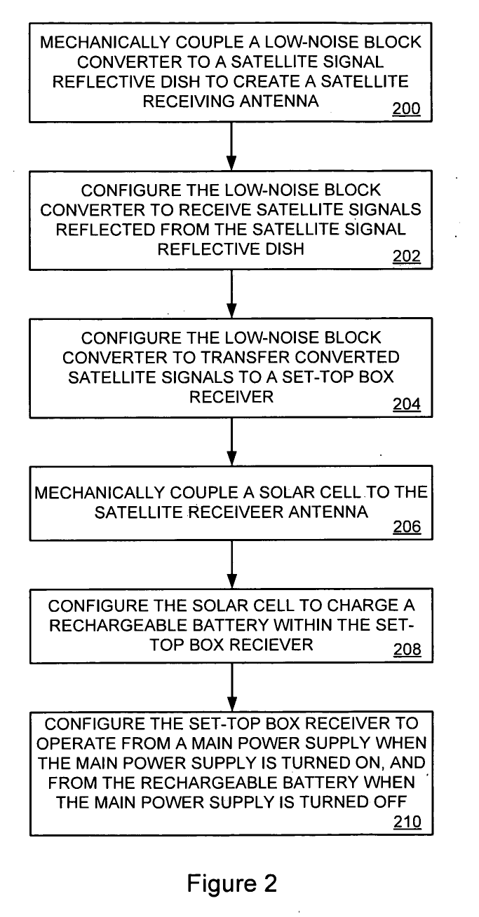

FIG. 2 is a flow chart of a method of constructing a satellite receiving system. In this example, a low-noise block converter is mechanically coupled to a satellite signal reflective dish (operation 200) resulting in a satellite receiving antenna. The low-noise block converter is configured to receive satellite signals reflected from the satellite signal reflective dish (operation 202). The low-noise block converter is also configured to transfer converted satellite signals to a set-top box receiver (operation 204). A solar cell is mechanically coupled to the satellite receiving antenna (operation 206). The solar cell is configured to charge a rechargeable battery within the set-top box receiver (operation 208). The set-top box receiver is configured to operate from a main power supply when the main power supply is turned on, and from the rechargeable battery when the main power supply is turned off (operation 210). In some examples, the set-top box receiver may be configured such that the background tasks run on power from the rechargeable battery even when the main power supply is turned on and charging the battery.

FIG. 3 illustrates a satellite receiving antenna 300. This example satellite receiving antenna 300 includes a satellite signal reflective dish 302, a low-noise block converter 306, and a solar cell 304. Solar cell 304 is coupled to the output 308 of the low-noise block converter 306 through link 310. In this example, output 308 is configured to be connected to set-top box receiver 106 through a coaxial cable (not shown). Solar cell 304 is configured to charge rechargeable battery 110 in set-top box 106 through the coaxial cable. Other embodiments may incorporate a separate link between solar cell 304 and rechargeable battery 110.

In this example, solar cell 304 is mechanically coupled with low-noise block converter 306. This configuration allows solar cell 304 to be coupled with the output 308 of low-noise block converter 306 with a minimum of wire and effort. In another embodiment, solar cell 304 may be configured, and satellite signal reflective dish 302 may be designed to reflect sunlight onto solar cell 304. In such an embodiment, solar cell 304 would be mechanically coupled with low-noise block converter 306 on a surface facing satellite signal reflective dish 302.

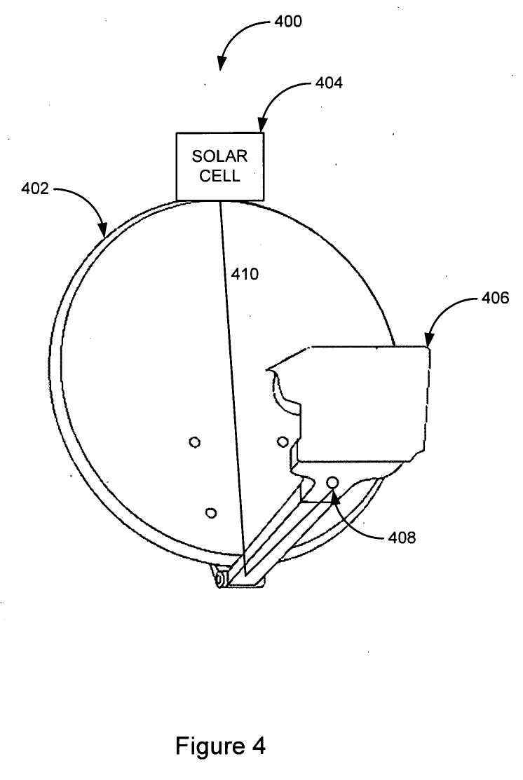

FIG. 4 illustrates a satellite receiving antenna 400. This example satellite receiving antenna 400 includes a satellite signal reflective dish 402, a low-noise block converter 406, and a solar cell 404. Solar cell 404 is coupled to the output 408 of the low-noise block converter 406 through link 410. In this example, output 408 is configured to be connected to set-top box receiver 106 through a coaxial cable (not shown). Solar cell 404 is configured to charge rechargeable battery 110 in set-top box 106 through the coaxial cable. Other embodiments may incorporate a separate link between solar cell 404 and rechargeable battery 110.

In this example, solar cell 404 is mechanically coupled to an edge of satellite signal reflective dish 402. If solar cell 404 is constructed to include a satellite signal reflective surface, it may be coupled to dish 402 such that it also reflects a satellite signal to low-noise block converter 406, thus increasing the strength of the signal received by low-noise block converter 406.

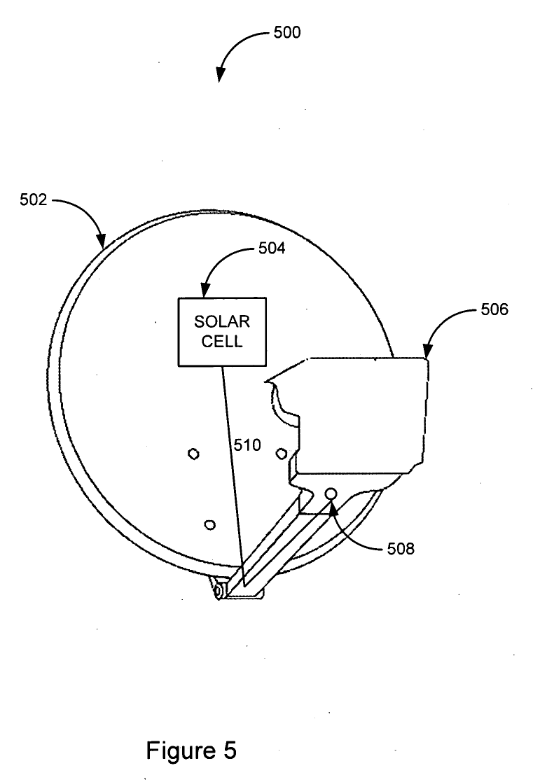

FIG. 5 illustrates a satellite receiving antenna 500. This example satellite receiving antenna 500 includes a satellite signal reflective dish 502, a low-noise block converter 506, and a solar cell 504. Solar cell 504 is coupled to the output 508 of the low-noise block converter 506 through link 510. In this example, output 508 is configured to be connected to set-top box receiver 106 through a coaxial cable (not shown). Solar cell 504 is configured to charge rechargeable battery 110 in set-top box 106 through the coaxial cable. Other embodiments may incorporate a separate link between solar cell 504 and rechargeable battery 110.

In this example, solar cell 504 is mechanically coupled to the front surface of satellite signal reflective dish 502. If solar cell 504 is constructed to include a satellite signal reflective surface, it may be coupled to dish 502 such that it also reflects a satellite signal to low-noise block converter 506, thus increasing the strength of the signal received by low-noise block converter 506. FIG. 5 is a simplified illustration of a satellite receiving antenna 500 including a solar cell 504. Other embodiments may vary in the size and location of solar cell 504 with respect to satellite signal reflective dish 502.

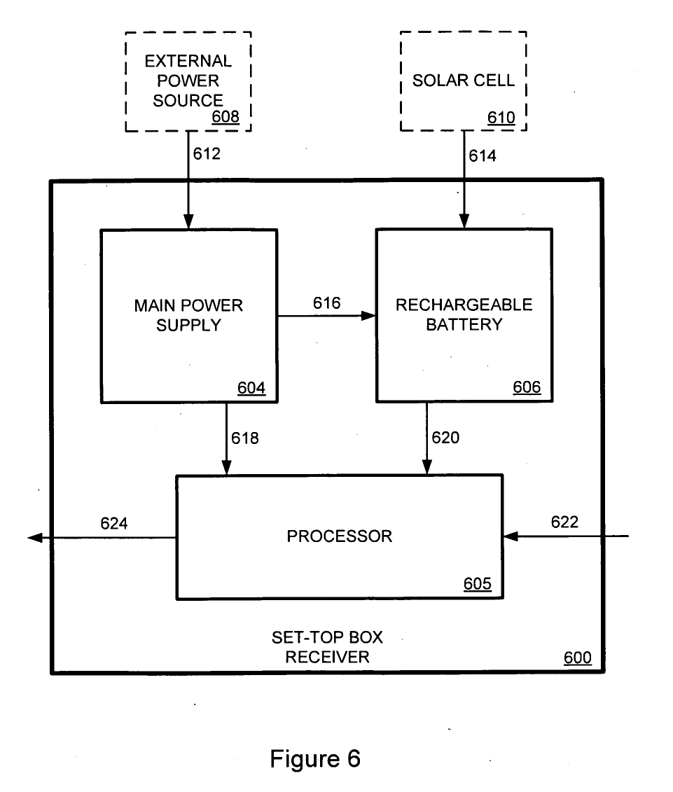

FIG. 6 illustrates a set-top box receiver 600. In this example, set-top box receiver 600 includes processor 605, main power supply 604, and rechargeable battery 606. Processor 605 is configured to receive power from main power supply 604 through link 618 when main power supply 604 is turned on, and to receive power from rechargeable battery 606 through link 620 when main power supply 604 is turned off. Main power supply 604 is configured to receive its power from external power supply 608 through link 612. External power source 608 is typically an ordinary household power outlet providing AC power at 110 Volts and 60 Hertz in the United States. Other external power sources may provide power having different characteristics.

Set-top box receiver 600 may contain additional elements not illustrated in FIG. 6 for purposes of clarity. These elements may include a down-converter, one or more tuners, a demodulator, demultiplexer, decryption circuit, audio and video decoders, and the like, for receiving the satellite signals and transferring them to the television or other output device.

In one embodiment, processor 605 may be one or more microprocessors, microcontrollers, digital signal processors (DSPs), or any other processor configured to execute software instructions for performing the various tasks identified with the processor 605, such as coordinating the activities of the other components of the set-top box receiver 600, as well as the specific operations discussed in greater detail below. The software may be stored in a data storage device, or a memory located internal to the processor 605. In another example, processor 605 may be a collection of hardware logic circuitry to perform the functions described below, or a combination of software and hardware elements.

In this example, rechargeable battery 606 is configured to receive power from solar cell 610 through link 614. Rechargeable battery 606 is also configured to receive power from main power supply 604 through link 616 when main power supply 604 is turned on. In other examples, rechargeable battery 606 may be configured to only receive power from solar cell 610.

Set-top box receiver 600 is configured such that processor 605 receives satellite signals over link 622, processes these signals and provides an output 624 to a television (not shown). Processor 605 is configured to perform a variety of background tasks while main power supply 604 is turned off. These tasks may include such processes as positive authorizations, code updates, encryption key changes, callback, and the like. Positive authorizations are piracy control features that set an end date, after which set-top box receiver 600 is automatically disabled. Every few days or weeks, set-top box receiver 600 receives a message via satellite updating the end date to some point in time in the future. If set-top box receiver 600 does not receive these messages updating the end date, it will cease to function on the last end date that it has successfully received.

Code updates are also sent via satellite to set-top box receiver 600 allowing set-top box receiver 600 to operate using the latest software available. Code updates may correct errors in previous code, or contain software upgrades enabling new features. Encryption key changes occur frequently as a method for preventing satellite signal piracy. In fact, these changes may occur several times a day in order to keep ahead of pirates. If set-top box receiver 600 does not receive the correct and latest encryption key, it will not operate.

Many set-top box receivers are configured to be connected to a telephone line (not shown). These receivers are configured to call a service center periodically to transmit information from the receiver to the satellite service provider. This information may include the identity of pay-per-view programming that has been ordered through the receiver, status information about the receiver, viewer preferences, satellite signal strength, and the like. This information may be necessary to provide correct billing to the user.

All of these background tasks may be performed by set-top box receiver 600 while main power supply 604 is turned off using the power provided by rechargeable battery 606. This allows the successful completion of these background tasks during times when set-top box receiver 600 is not connected to external power source 608 through link 612.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A satellite receiving system, comprising:
an antenna;
a solar cell mechanically coupled directly to the antenna; and
a set-top box receiver comprising:
a rechargeable battery electrically coupled to the solar cell; and
a main power supply;
wherein the solar cell is configured to charge the rechargeable battery; and
wherein the set-top box is configured to operate from either the rechargeable battery or the main power supply, and to operate from the rechargeable battery when the main power supply is turned off.

2. The satellite receiving system of claim 1,
wherein the set-top box receiver is configured to operate in a low-power mode from the rechargeable battery when the main power supply is turned off.

3. The satellite receiving system of claim 1,
wherein the antenna includes a satellite signal reflective dish; and
wherein the solar cell has a satellite signal reflective surface and is configured to operate as part of the satellite signal reflective dish.

4. The satellite receiving system of claim 1,
wherein the main power supply is configured to charge the rechargeable battery when the main power supply is turned on.

5. The satellite receiving system of claim 1,
wherein the set-top box receiver is configured to perform positive authorizations while the main power supply is turned off.

6. The satellite receiving system of claim 1,
wherein the set-top box receiver is configured to perform code updates while the main power supply is turned off.

7. The satellite receiving system of claim 1,
wherein the set-top box receiver is configured to perform encryption key changes while the main power supply is turned off.

8. The satellite receiver system of claim 1,
wherein the set-top box receiver is configured to perform callbacks while the main power supply is turned off.

9. The satellite receiver system of claim 1,
wherein the antenna is electrically coupled to the set top-box receiver through a coaxial wire, and the rechargeable battery is charged by the solar cell through the coaxial wire.

10. A satellite receiver antenna comprising:
a satellite signal reflective dish;
a low-noise block converter configured to receive satellite signals reflected from the satellite signal reflective dish;
a solar cell; and
an output configured to transfer converted satellite signals from the low-noise block converter to a set top box receiver; and
wherein the solar cell is configured to charge a battery within the set-top box.

11. The satellite receiver antenna of claim 10,
wherein the solar cell is configured to charge the battery within the set-top box through the output.

12. The satellite receiver antenna of claim 10,
wherein the solar cell has a satellite signal reflective surface and is configured to operate as part of the satellite signal reflective dish.

13. The satellite receiver antenna of claim 10,
wherein the solar cell is mechanically coupled directly with the satellite signal reflective dish.

14. The satellite receiver antenna of claim 10,
wherein the solar cell is mechanically coupled directly with the low noise block converter and is electrically coupled with the output.

15. A satellite set top-box receiver comprising:
a processor;
a satellite signal input electrically coupled with the processor;
a main power supply configured to supply electrical power to the processor; and
a rechargeable battery configured to supply electrical power to the processor when the main power supply is turned off, and configured to be recharged from a solar cell attached to a satellite receiver antenna.

16. The satellite set top box receiver of claim 15,
wherein the rechargeable battery is configured to be recharged from the solar cell attached to the satellite receiver antenna through the satellite signal input.

17. The satellite set top box receiver of claim 15,
wherein the processor is configured to operate in a low-power mode from the rechargeable battery when the main power supply is turned off.

18. A method for constructing a satellite receiver system comprising:
mechanically coupling a low-noise block converter to a satellite signal reflective dish;
configuring the low-noise block converter to receive satellite signals reflected from the satellite signal reflective dish;
configuring the low-noise block converter to transfer converted satellite signals to a set-top box receiver;
mechanically coupling a solar cell to the satellite signal reflective dish;
configuring the solar cell to charge a rechargeable battery within the set-top box receiver; and
configuring the set-top box receiver to operate from a main power supply when the main power supply is turned on, and to operate from the rechargeable battery when the main power supply is turned off.

19. The method of claim 18, further comprising
configuring the solar cell to operate as part of the satellite signal reflective dish, wherein the solar cell has a satellite signal reflective surface.

20. The method of claim 18, further comprising:
configuring the set-top box receiver to operate in a low-power mode when the main power supply is turned off.
